(19) United States
(12) Patent Application Publication
(10) Pub. No.: US 2026/0227212 A1
(43) Pub. Date: Aug. 6, 2026

(54) Commodity Monitoring Systems, Cable Assemblies, Cable Sensor Nodes, And Related Methods And Systems

(71) Applicant: GSI Electronique Inc, Saint-Hubert (CA)

(72) Inventors: Patrick LESSARD, St-Hubert (CA); Fajar Setio ADRI PUTRO, St-Hubert (CA)

(73) Assignee: GSI Electronique Inc, Saint-Hubert, QC (CA)

(21) Appl. No.: 19/149,064

(22) PCT Filed: Dec. 11, 2023
(86) PCT No.: PCT/IB2023/062462

§ 371 Date: Jul. 17, 2025

Related U.S. Application Data
(60) Provisional application No. 63/499,132, filed on Apr. 28, 2023.
(60) Provisional application No. 63/506,418, filed on Jun. 6, 2023.

(30) Foreign Application Priority Data
Jan. 22, 2023 (GB) 2300935.0
Feb. 13, 2023 (GB) 2302049.8

(51) Int. Cl. G01D 11/24

(52) U.S. Cl. CPC G01D 11/24

(57) ABSTRACT

A commodity monitoring system includes at least one computing device, a container for storing a commodity, and a cable assembly. The cable assembly includes a plurality of cables, each cable comprising a pair of conductors surrounded by a cable jacket and a plurality of sensor nodes secured to the plurality of cables. Each sensor node includes a segment of a cable, an injection molded housing structure formed over the cable and extending through a slot extending through the cable, a circuit board disposed within the housing structure and between conductors of the pair of conductors, a seal member disposed over the circuit board and in contact with the housing structure, a cap member disposed over the seal member, and at least one fastener securing the seal member and the cap member to the housing structure.

### FIELD

Embodiments generally relate to grain monitoring. In particular, embodiments relate to sensor nodes secured to cables used in the monitoring of stored commodities (e.g., grain).

### BACKGROUND

In the monitoring of commodities within storage bins, it is important to monitor certain parameters to keep the stored commodities cool and dry. Based on the monitored parameters, determinations that the stored commodities need aeration and/or by churning may be made. In cable-based monitoring, parameters are typically monitored via sensor nodes suspended by cables. When cables are installed in the storage bins, movement of the cables based on, for instance, the ingress, egress, or churning of grain, may lead to breaks or disruptions in connections to the sensor nodes (e.g., circuitry of the sensor nodes), resulting in a loss of data from the affected sensor nodes.

### BRIEF SUMMARY

Some embodiments include a sensor node includes a segment of a cable having a pair of conductors surrounded by a cable jacket, an injection molded housing structure formed over the cable and extending through a slot extending through the cable, a circuit board disposed within the housing structure and between conductors of the pair of conductors, a seal member disposed over the circuit board and in contact with the housing structure, a cap member disposed over the seal member, and at least one fastener securing the seal member and the cap member to the housing structure.

The circuit board may include a plurality of spring contacts extending away from lateral sides of the circuit board and configured to contact the pair of conductors of the cable.

The at least one fastener may include a circle clamp extending around the cap member and the housing structure within a plane to which a longitudinal axis of the cable is orthogonal.

The seal member may include at least one key aperture for aligning the seal member relative to the cap member.

The housing structure may include a seating structure extending through the cable and between the pair of conductors.

Each lateral side surface of the circuit board may face a respective conductor of the pair of conductors, and where each lateral side surface of the circuit board is oriented at least substantially perpendicular to a plane extending between center longitudinal axes of the pair of conductors of the cable and within which the center longitudinal axes of the pair of conductors lie.

The circuit board may include one or more sensors.

The at least one spring contact of the plurality of spring contacts may extend from a first lateral side of the circuit board, and at least one other spring contact of the plurality of spring contacts may extend from a second, opposite lateral side of the circuit board.

A center longitudinal axis of the circuit board may be at least substantially collinear with a center longitudinal axis of the cable.

The cap member may include at least key structure configured to extend through the at least one key aperture of the seal member.

The housing structure may include a recess within which the seal member and the cap member are received.

The housing structure may further include an inclined recess extending between the recess and an outer surface of the housing structure.

The cap member may include a recessed aperture extending through the cap member.

The sensor node may also include at least one filter or membrane disposed within the recessed aperture of the cap member and providing a hydrophobic vent.

The receiving channel may extend through the seating structure.

The one or more sensors may include at least one of a temperature sensor, a moisture sensor, a humidity sensor, a relative humidity sensor, or a carbon dioxide sensor.

One or more embodiments include a method of forming a sensor node on a cable. The method may include forming an opening in a cable jacket of the cable, injection molding a housing structure over the opening in the cable jacket of the cable and at least partially through the cable such that at least a portion of the housing structure is formed between two conductors of the cable, disposing a circuit board within the housing structure such that a first lateral side of the circuit board faces a first conductor of the two conductors and a second lateral side of the circuit board faces a second conductor of the two conductors, disposing a seal member over the circuit board and onto the housing structure, aligning a cap member over the seal member, and securing the cap member to the housing structure via at least one fastener.

Aligning the cap member over the seal member may include aligning at least one key structure of the cap member within at least one key aperture of the seal member.

Securing the cap member to the housing structure via the at least one fastener may include securing the cap member to the housing structure via at least one circle clamp.

One or more embodiments include a commodity monitoring system. The commodity monitoring system may include at least one computing device, a container for storing a commodity, a cable assembly installed within the container and in communication with the at least one computing device. The cable assembly may include a plurality of cables, each cable may include a pair of conductors surrounded by a cable jacket. The commodity monitoring system also includes a plurality of sensor nodes secured to the plurality of cables, each cable of the plurality of cables may include at least one sensor node of the plurality of sensor nodes secured thereto, each sensor node of the plurality of sensor nodes may include a segment of a cable of the plurality of cables, an injection molded housing structure formed over the cable and extending through a slot extending through the cable, a circuit board disposed within the housing structure and between conductors of the pair of conductors, a seal member disposed over the circuit board and in contact with the housing structure, a cap member disposed over the seal member, and at least one fastener securing the seal member and the cap member to the housing structure.

Other technical features may be readily apparent to one skilled in the art from the following figures, descriptions, and claims.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

While the specification concludes with claims particularly pointing out and distinctly claiming what are regarded as embodiments of the present disclosure, various features and advantages may be more readily ascertained from the following description of example embodiments when read in conjunction with the accompanying drawings, in which:

FIG. 1 shows a schematic representation of a commodity monitoring system having a cable assembly and sensor nodes according to one or more embodiments of the present disclosure;

FIG. 2A shows a perspective view of a sensor node secured to a cable according to one or more embodiments of the present disclosure;

FIG. 2B shows a perspective view of the sensor node of FIG. 2A;

FIG. 2C shows an exploded, perspective view of the sensor node of FIG. 2A;

FIG. 2D shows another exploded, perspective view of the sensor node of FIG. 2A.

FIG. 3A shows a perspective view of a circuit board of a sensor node from a first lateral side;

FIG. 3B shows a perspective view of the circuit board of FIG. 3A from a second, opposite lateral side;

FIG. 4 shows an exploded, perspective view of a housing structure and a circuit board of a sensor node according to embodiments of the present disclosure;

FIG. 5 shows another an exploded, perspective view of the housing structure and the circuit board of the sensor node of FIG. 4;

FIG. 6 shows a side view of the housing structure and the circuit board of the sensor node of FIG. 4;

FIG. 7 shows another side view of the housing structure and the circuit board of the sensor node of FIG. 4;

FIG. 8A shows a perspective view of a cap member of a sensor node according to one or more embodiments of the disclosure;

FIG. 8B shows a side view of the cap member of FIG. 8A;

FIG. 9 shows a perspective view of a housing structure of a sensor node according to one or more embodiments of the disclosure;

FIG. 10A shows a side view of a sensor node according to one or more embodiments of the disclosure;

FIG. 10B shows a cross-sectional view of the sensor node of FIG. 10A;

FIG. 11 shows a perspective view of a back side of the cap member of FIG. 8A;

FIG. 12 shows a side view of the cap member of FIG. 8A;

FIG. 13 shows a schematic representation of a circuit board of a sensor node according to one or more embodiments of the present disclosure; and

FIG. 14 shows a schematic representation of a cable and sensor nodes according to some embodiments of the present disclosure.

### DETAILED DESCRIPTION

Illustrations presented herein are not meant to be actual views of any particular storage container, cable assembly, cable, sensor node, component, or system, but are merely idealized representations that are employed to describe embodiments of the disclosure. Additionally, elements common between figures may retain the same numerical designation for convenience and clarity.

The following description provides specific details of embodiments. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all the elements that form a complete structure or assembly. Only those process acts and structures necessary to understand the embodiments of the disclosure are described in detail below. Additional conventional acts and structures may be used. The drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, any relational term, such as “first,” “second,” “top,” “bottom,” “upper,” “lower,” “above,” “beneath,” “side,” “outer,” “inner,” etc., is used for clarity and convenience in understanding the disclosure and accompanying drawings, and does not connote or depend on any specific preference or order, except where the context clearly indicates otherwise. For example, these terms may refer to an orientation of elements of a sensor node, a cable, and/or a cable assembly as illustrated in the drawings. Additionally, these terms may refer to an orientation of elements of a sensor node, a cable, and/or a cable assembly when utilized in a conventional manners.

As used herein, any relational term, such as “first,” “second,” “top,” “bottom,” “upper,” “lower,” “above,” “beneath,” “side,” etc., is used for clarity and convenience in understanding the disclosure and accompanying drawings, and does not connote or depend on any specific preference or order, except where the context clearly indicates otherwise. For example, these terms may refer to an orientation of elements of a dual linear delta assembly and/or linear delta system when utilized in a conventional manner. Furthermore, these terms may refer to an orientation of elements of a dual linear delta assembly and/or linear delta system when as illustrated in the drawings.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

As used herein, the term “and/or” includes any and all combinations of one or more of the associated listed items.

Embodiments of the disclosure include a cable assembly for monitoring a commodity (e.g., a grain) within a container (e.g., a storage bin) and having cables and sensor nodes secured to the cables. The sensor nodes may include housing structures that are injection molded over and through respective cables. Furthermore, portions (e.g., seating structures) of the housing structures may formed and interposed between two electrical conductors of the cables. Circuit boards (e.g., printed circuit boards) may be disposed within the seating structures of the housing structures and may be interposed between the two electrical conductors of the cables. The circuit boards may include a plurality of spring contacts (e.g., biased contacts) extending from lateral sides of the circuit boards, extending through the seating structures of the housing structures, and sized and shaped to contact the conductors of the cables and establish electrical connections between the circuit boards and the conductors of the cables.

Some embodiments of the disclosure include sensor nodes that are arranged in spaced-apart positions along cables that are affixed to top structures of a storage container (e.g., grain storage bin). The sensor nodes may include monitoring circuitry, and a printed circuit board of each sensor node may be secured between conductors of a respective cable to provide a relatively robust connection between the monitoring circuitry and the conductors of the cable. For instance, the circuit board of each sensor node may include a plurality of spring contacts attached to each lateral side of the circuit board (e.g., one or more spring contacts on one lateral side, and one or more spring contacts on an opposite lateral side). The plurality of spring contacts secure the circuit board between the conductors of the cable, while providing conductive paths for power/data and ground. For instance, the plurality of spring contacts may provide resistance to movement of the circuit board relative to the conductors, even when the conductors move or deflect, which may provide robust and persistent connections between the circuit board and the conductors.

One or more embodiments include at least one computing device, a container for storing a commodity, and a cable assembly installed within the container and in communication with the at least one computing device. The cable assembly may include a plurality of cables, each cable including a pair of conductors and a plurality of sensor nodes secured to the plurality of cables, each cable of the plurality of cables having at least one sensor node of the plurality of sensor nodes secured thereto. Each sensor node of the plurality of sensor nodes may include a cable having a pair of conductors surrounded by a cable jacket, an injection molded housing structure formed over the cable and extending through a slot extending through the cable and between the pair of conductors, and a circuit board disposed within the housing structure and interposed between the pair of conductors of the cable.

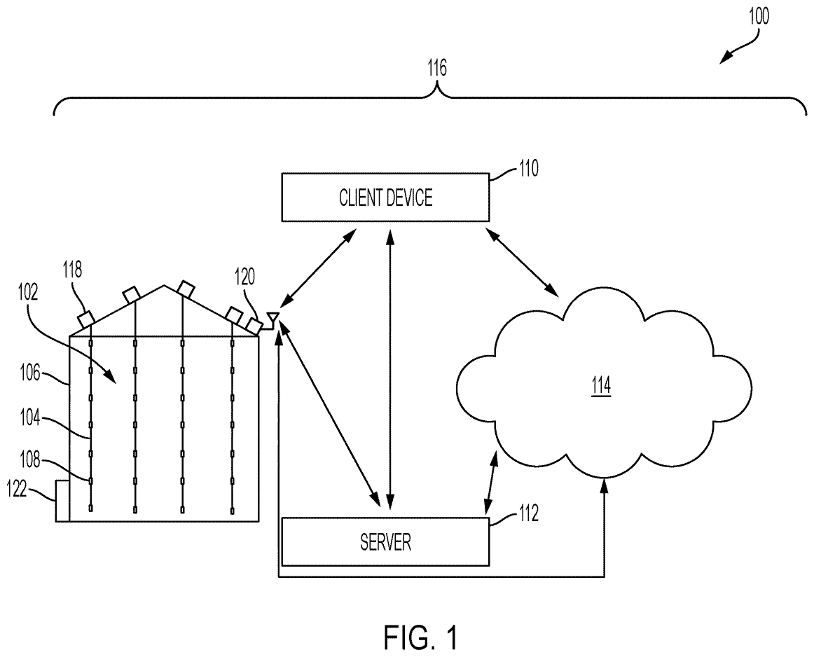

FIG. 1 shows a schematic diagram of an environment 100 in which a sensor node (e.g., a cable sensor node) may be implemented and operated according to one or more embodiments of the present disclosure. The environment 100 may include a cable assembly 102 having a plurality of cables 104 suspended within a container 106, one or more sensor nodes 108 coupled to each of the plurality of cables 104, at least one client device 110, at least one server 112, and a network 114. The at least one server 112, the at least one client device 110, and the cable assembly 102 may communicate via the network 114 and may form a commodity monitoring system 116. Although FIG. 1 illustrates a particular arrangement of the at least one client device 110, the at least one server 112, the cable assembly 102, and the network 114, various additional arrangements are possible. For example, the at least one server 112 can communicate directly with the at least one client device 110, and/or the cable assembly 102, thereby bypassing the network 114.

The container 106 may include a grain storage bin. Furthermore, while a particular geometry is depicted in FIG. 1, it understood that the container 106 may include one or more containers of other geometries, for the same contents (e.g., grain) or other contents, with a different arrangement and/or quantity of inlet, outlet, and/or side ports.

The cable assembly 102 may include a plurality of cables 104 coupled to and suspended from one or more top structures of a container 106. In some embodiments, one or more of the plurality of cables 104 may be coupled to a floor of the container 106 via, for instance, a floor anchor. In some embodiments, each cable 104 of the plurality of cables 104 may be operably coupled to a respective cable hub 118, and each cable hub 118 may be in communication (e.g., via wired and/or wireless communication) with a communications gateway 120, which in turn may be in communication with the network 114, and as a result, the at least one client device 110, and/or the at least one server 112. In additional embodiments, two or more cables 104 or all the cables 104 may be operably coupled to a single cable hub 118, and the cable hub 118 may be in communication (e.g., via wired and/or wireless communication) with a communications gateway 120, which in turn may be in communication with the network 114, and as a result, the at least one client device 110, and/or the at least one server 112. In some embodiments, each cable 104 of the plurality of cables 104 may be operably coupled to a multiplexor (e.g., data selector).

The cable assembly 102 may be utilized to monitor contents (e.g., a commodity) within the container 106. As noted above, each cable 104 of the cable assembly 102 may have one or more sensor nodes 108 coupled (e.g., secured) to the cable 104. In some embodiments, a given cable 104 may include a plurality of sensor nodes 108, and the plurality of sensor nodes 108 may be spaced apart from each along a longitudinal length of the given cable 104. As a result, when a commodity (e.g., a grain) is stored within the container 106, the sensor nodes 108 of each cable 104 may be vertically distributed throughout the commodity.

The one or more sensor nodes 108 may include one or more of humidity sensors, relative humidity sensors, temperature sensors, moisture sensors, and/or carbon dioxide (CO₂) sensors. Spacing between sensor nodes 108 may be selected based on the type of sensors and/or type of commodity. Additionally, a quantity of cables 104 may be selected based at least partially on one or more of a region (e.g., climate) in which the container 106 is located, a type of commodity stored, a size of the container 106, air flow conditions within the container 106, and the types of sensors of the sensor nodes 108.

In some embodiments, a user can interface with one or more of the at least one client device 110, for example, to communicate with the at least one server 112, and to utilize the commodity monitoring system 116 to monitor contents of the container 106. The user may include one or more operators of the container 106 and/or commodity monitoring system 116. Although FIG. 1 shows only one client device 110 the commodity monitoring system 116 can include any number of client devices 110 in communication with the network 114, the at least one server 112, and/or the cable assembly 102.

In some embodiments, the client device 110 may include a client application installed thereon. In one or more embodiments, the client application can be associated with the commodity monitoring system 116. For example, the client application may allow the client device 110 to directly or indirectly interface with other elements (e.g., the cable assembly 102, the at least one server 112) of the commodity monitoring system 116. The client application also enables a user (e.g., an operator) to initiate measurements via the commodity monitoring system 116 and observe any results of the measurements (e.g., measured humidity, measure temperatures, measured moisture levels, etc.).

Both the at least one client device 110 and the at least one server 112 (and the commodity monitoring system 116) can represent various types of computing devices with which operators can interact. For example, the at least one client device 110 and/or the at least one server 112 may include a mobile device (e.g., a cell phone, a smartphone, a PDA, a tablet, a laptop, a watch, a wearable device, etc.). In some embodiments, however, the at least one client device 110 and/or at least one server 112 can be a non-mobile device (e.g., a desktop or server). In some embodiments, the at least one server 112 may include a cloud computing platform and may be configured to perform processing required to implement one or more portions of the cable 104. In one or more embodiments, the at least one server 112 may include a web server that provides a web site that can be used by operators monitoring the contents of the container 106 via a remote client device 110.

Referring still to FIG. 1, while the commodity monitoring system 116 is depicted as being across multiple devices such as, for example, the server 112, the client device 110, and the gateway 120. However, the disclosure is not so limited, rather, the commodity monitoring system 116 may be a portion of (e.g., implemented by) the server 112 and/or may be implemented at one or more of the client device 110, the cable hubs 118, and/or the server 112. In some embodiments, the commodity monitoring system 116 may be implemented at a computing device that is local to the container 106 (e.g., edge computing). In some embodiments, the commodity monitoring system 116 may be implemented at different devices of the environment 100 operating according to a primary-secondary configuration or peer-to-peer configuration. For purposes of illustration and convenience, implementation of the commodity monitoring system 116 is described herein as being implemented across multiple devices, with the understanding that functionality may be implemented in other and/or additional devices.

The network 114 may include one or more networks, such as the Internet, and can use one or more communications platforms or technologies suitable for transmitting data and/or communication signals. As a non-limiting example, the network 114 may utilize one or more of near field communication (NFC), BLUETOOTH©, LoRa, wireless/cellular networks, wide area networks (WAN), wired communications, or any other conventional network for transmitting data and/or communication signals between the cable assembly 102, the client device 110, and the server 112.

Referring still to FIG. 1, in some embodiments, one or more of the at least one client device 110, the cable assembly 102, or the at least one server 112, may include a display for displaying data regarding measurements obtained via the cable assembly 102. In some embodiments, the data may include one or more parameters of commodity within the container 106. The parameters may include one or more of temperature, humidity, relative humidity, moisture, or carbon dioxide. In some embodiments, the cable 104 may utilize the parameters to determine when to actuate commodity management devices 122 of the container 106 to affect conditions of the commodity. The commodity management devices 122 may include one or more of heaters, fans, blowers, churners, vents, etc.

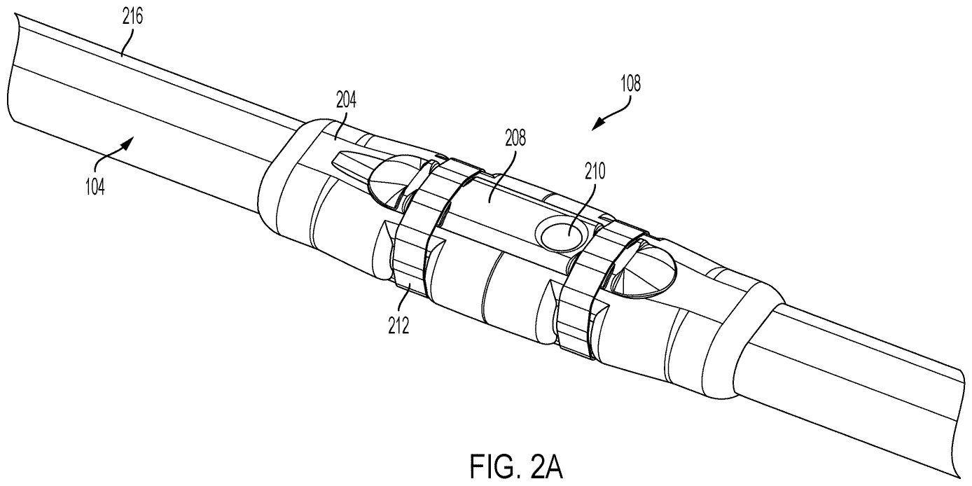

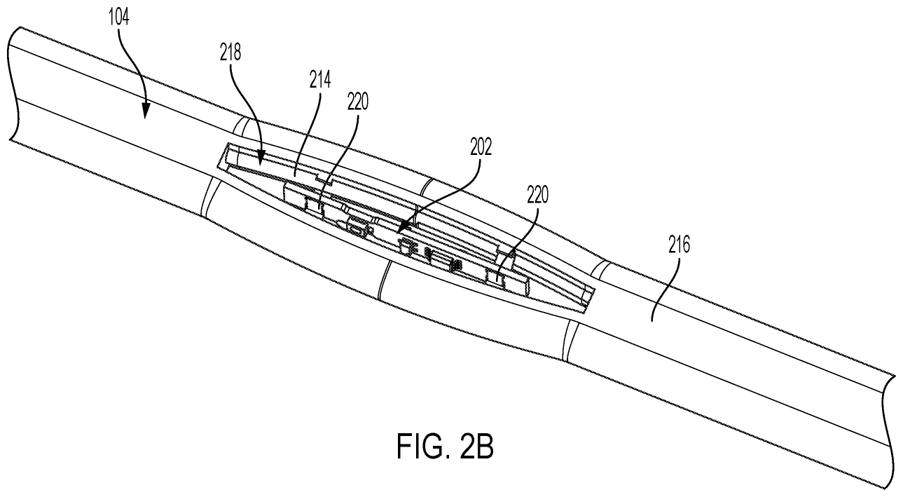

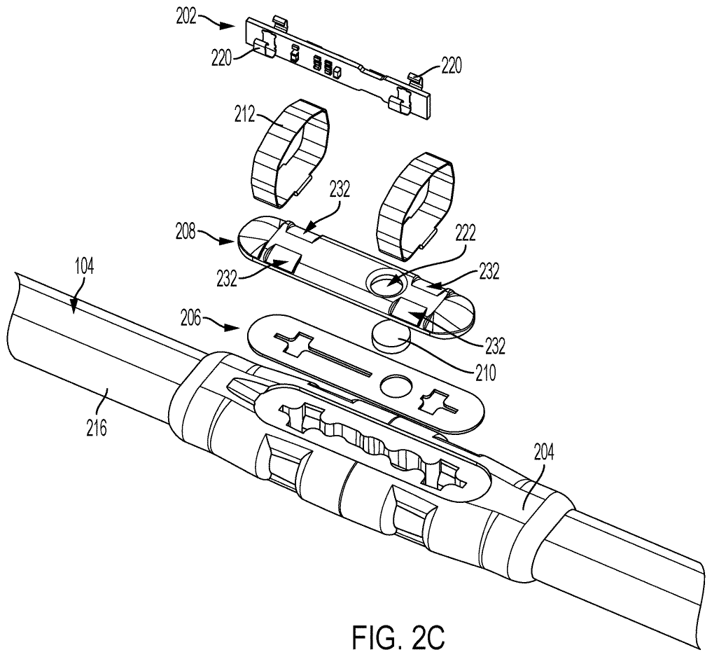

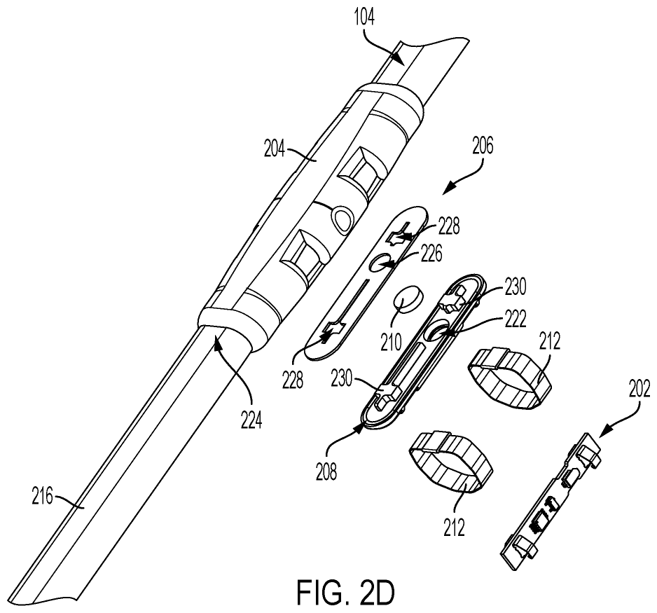

FIG. 2A shows a perspective view of a sensor node 108 coupled to a cable 104 according to one or more embodiments of the disclosure. FIG. 2B shows the sensor node 108 of FIG. 2A with portions of the sensor node 108 omitted in order to show internal components of the sensor node 108 and the cable 104. FIG. 2C shows a first perspective, exploded view of the sensor node 108 and the cable 104 of FIG. 2A. FIG. 2D shows a second perspective, exploded view of the sensor node 108 and the cable 104 of FIG. 2A. Referring to FIG. 2A through FIG. 2D together, the sensor node 108 may include a circuit board 202, a housing structure 204, a seal member 206, a cap member 208, at least one filter and/or membrane 210, and one or more fasteners 212. The cable 104 may include one or more conductors 214 (e.g., wires, metal cables, etc.) within a cable jacket 216.

As depicted in FIG. 2B, the cable 104 may include a slot or opening 218 formed through the cable jacket 216 of the cable 104 and exposing a pair of conductors 214 of the cable 104. For instance, the slot or opening 218 may be formed through one or more of a punching process, a machining process, a grinding process, a drilling process, and/or a heating process. In some embodiments, the slot or opening 218 may extend through both sides of the cable 104 (e.g., the cable jacket 216 on both sides of the cable 104). In other embodiments, the slot or opening 218 may extend through only one side of the cable 104 (e.g., through only one side of the cable jacket 216 in a direction orthogonal to a longitudinal axis of the cable 104). As is described in greater detail below, the pair of conductors 214 are utilized for both data transfer (e. g, operation of the sensor nodes 108), and as structure (e.g., structural support) of the sensor nodes 108 (e.g., supporting the circuit boards 202 within the sensor nodes 108).

In one or more embodiments, the pair of conductors 214 may include any conventional conductors, such as for example, copper, aluminum, nickel, stainless steel, galvanized steel, a metal alloy, or a metal-containing material. In some embodiments, each conductor 214 may have a diameter within a range of about 3.0 millimeters (mm) to about 15 millimeters (mm). For example, each conductor 214 may have a diameter of about 4.75 millimeters (mm). In some embodiments, a distance between center longitudinal axes of the conductors 214 may be within a range of about 3.0 millimeters (mm) and about 8.0 millimeters (mm). As a non-limiting example, the distance between center longitudinal axes of the conductors 214 may be about 6.35 millimeters (mm). In some embodiments, the cable jacket 216 may include an insulative material, such as, for example, a high-density polyethylene (HDPE) material.

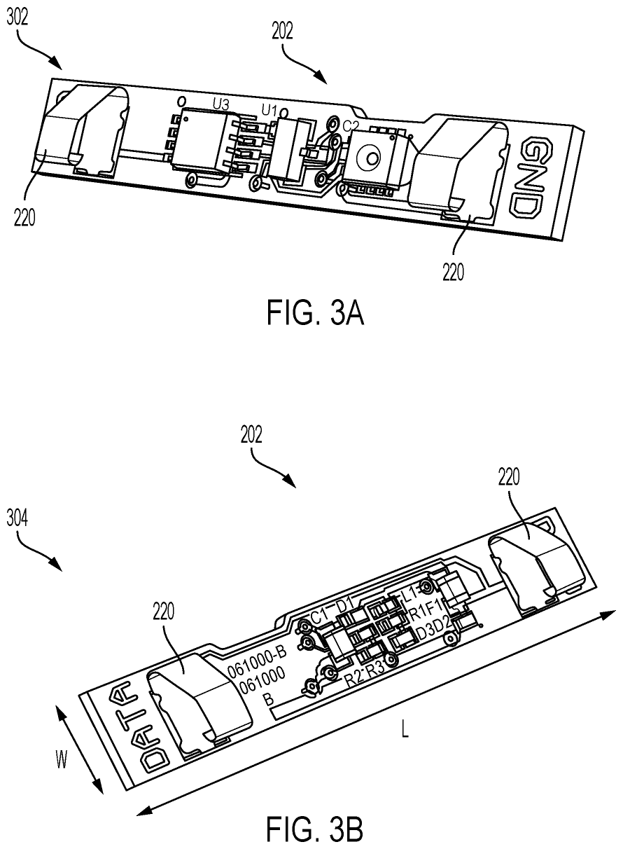

FIG. 3A shows a perspective view of a first lateral side 302 of the circuit board 202 of FIG. 2A through FIG. 2C. FIG. 3B shows a perspective view of a second, opposite lateral side 304 of the circuit board 202. Referring to FIGS. 2A-3B together, the circuit board 202 may include one or more spring contacts 220 extending laterally away from the circuit board 202 on both lateral sides of the circuit board 202 and configured to contact the pair of conductors 214 of the cable 104 when the circuit board 202 is inserted into the slot or opening 218 formed through the cable jacket 216. In some embodiments, the one or more spring contacts 220 may include one or more of c-clip spring contacts, box-clip spring contacts, y-clip spring contacts, spring-finger contacts, shield-finger contacts, or pogo-pin contacts. In some embodiments, the spring contacts 220 of the circuit board 202 may vary in type. Furthermore, while four spring contacts 220 are depicted in FIG. 2A through FIG. 3B, the disclosure is not so limited, and the circuit board 202 may include fewer or more spring contacts 220 (e.g., six, eight, ten, or more spring contacts 220).

In some embodiments, the first lateral side 302 of the circuit board 202 may be referred to herein as a ground (GND) lateral side, and the second lateral side 304 of the circuit board 202 may be referred to herein as a data lateral side. Furthermore, on one or more of the first lateral side 302 and the second lateral side 304, the spring contacts 220 of that side may be located proximate longitudinal ends of the circuit board 202. For example, when a given lateral side includes two spring contacts 220, a first spring contact 220 may be located proximate a first longitudinal end of the circuit board 202, and a second spring contact 220 may be located proximate a second, opposite longitudinal end of the circuit board 202. In further embodiments, the spring contacts 220 on a given lateral side may be located proximate a center of the circuit board 202 or any other location on the given lateral side of the circuit board 202.

In some embodiments, the spring contacts 220 may include a conductive material (e.g., metallic material, such as copper, gold, silver, etc.), or non-metallic material, such as carbon-fused material (e.g., carbon-fused plastic). In some embodiments, the spring contacts 220 may include a combination of conductive materials (e.g., gold-plated steel, etc.) or a combination of conductive and non-conductive materials (e.g., a combination of gold-plated steel and plastic). As a non-limiting example, one of the spring contacts 220 of a given lateral side of the circuit board 202 may include a conductive material and may be utilized to create an electrical connection with a respective conductor 214 of the cable 104 and to secure the circuit board 202 within the cable 104, and another of the spring contacts 220 of the given lateral side of the circuit board 202 may include non-conductive material and may be utilized to secure the circuit board 202 within the cable 104. A variety of combinations of spring contacts 220 (e.g., conductive and non-conductive, different quantities, different locations, different types, etc.) may be implemented and fall within the scope of the disclosure. In one embodiment, the circuit board 202 is conformally coated, such as to reduce the risk of damage due to moisture.

In some embodiments, the circuit board 202 may have a longitudinal length (L) within a range of about 14 millimeters (mm) to about 35.00 millimeters. For example, the circuit board 202 may have a longitudinal length (L) of about 24.0 millimeters (mm). Additionally, the circuit board 202 may have a width (W) within a range of about 3.0 millimeters (mm) to about 10.00 millimeters. For example, the circuit board 202 may have a width (W) of about 5.0 millimeters (mm). It will be understood that other dimensions may be selected based on cable 104 dimensions and are within the scope of the disclosure.

Referring again to FIG. 2A through FIG. 2D, the cap member 208 may include at least one recessed aperture 222 extending therethrough. Furthermore, the at least one recessed aperture 222 of the cap member 208 may be sized and shaped to receive a respective filter and/or membrane 210. For example, in some embodiments, a filter and/or membrane 210 may be press-fit and/or secured via an adhesive into the at least one recessed aperture 222 of the cap member 208. The cap member 208 is described in greater detail below.

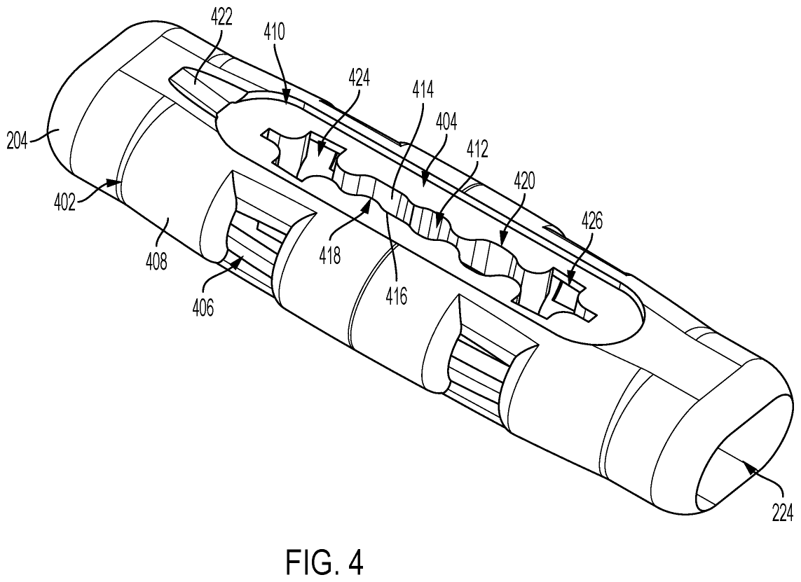

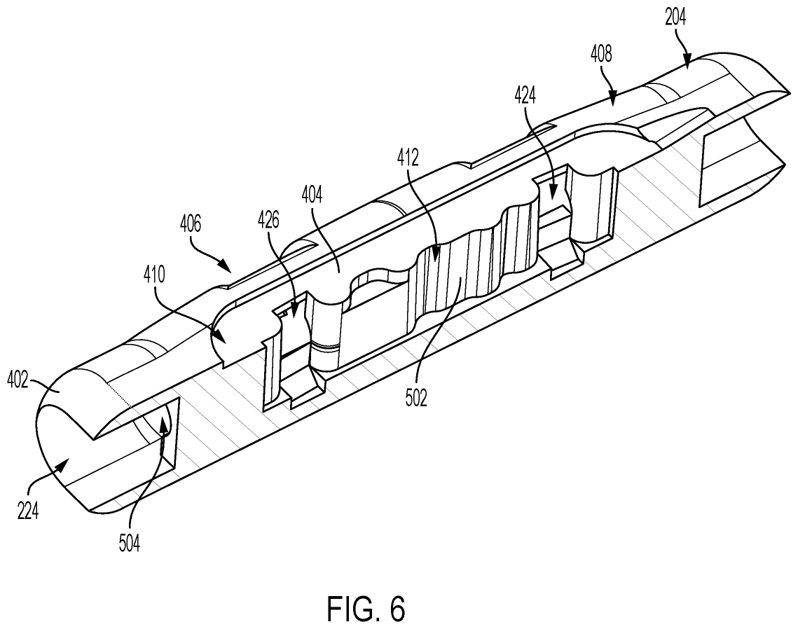

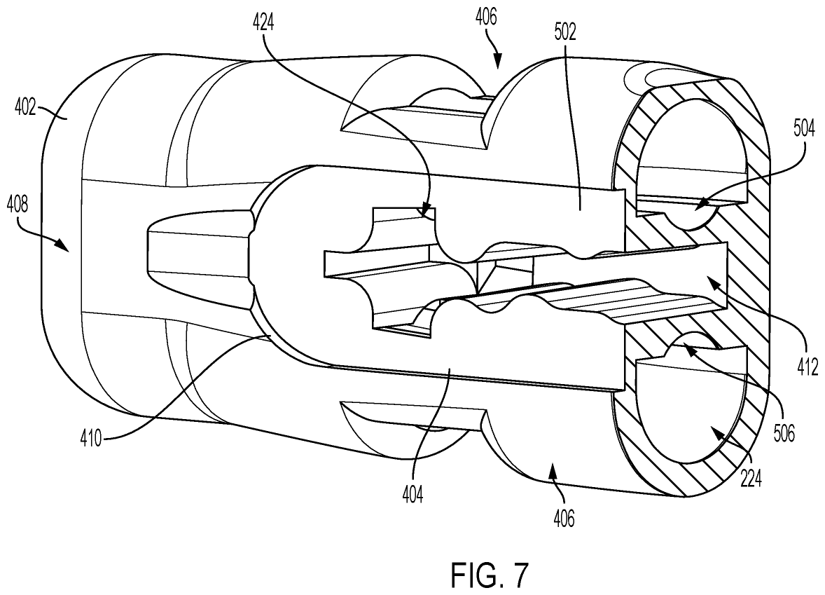

FIG. 4 through FIG. 7 shows various views of the housing structure 204 according to one or more embodiments of the disclosure. In some views, one or more elements of the sensor node 108 are removed in order to better show elements of the housing structure 204. Referring to FIG. 2A through FIG. 7 together, the housing structure 204 may include an outer shell 402 and a seating structure 404 for seating the circuit board 202 (FIG. 2C) and for securing the circuit board (FIG. 2C) relative to the cable 104. The outer shell 402 may at least partially encapsulate a segment (e.g., a length) of the cable 104, and the outer shell 402 may extend completely around an outer circumference of the cable 104 in at least some locations. In other words, at least some segments of the cable 104 may be at least substantially entirely surrounded by the outer shell 402.

For example, the outer shell 402 may define an interior cavity 224 that extends through the outer shell 402 along a longitudinal axis of the outer shell 402. Furthermore, the interior cavity 224 may be sized and shaped to house (e.g., enclose) a segment of the cable 104 (e.g., a longitudinal length of the cable 104 at least substantially equal in length to the longitudinal length of the housing structure 204). The seating structure 404 may extend between two opposite lateral sides of the outer shell 402 and across the interior cavity 224 within the housing structure 204. Furthermore, when the housing structure 204 is molded to a cable 104, the seating structure 404 may extend and be oriented between the two conductors 214 of the cable 104. For instance, when the housing structure 204 is molded to a cable 104, the seating structure 404 may extend through the slot or opening 218 (FIG. 2B) formed through the cable 104. In some embodiments, the seating structure 404 may extend completely through the cable 104.

In some embodiments, the outer shell 402 may further define one or more windows 406 extending from an outer surface 408 of the outer shell 402 to the interior cavity 224 of the outer shell 402. Accordingly, when the housing structure 204 is molded to a cable 104, the one or more windows 406 may expose one or more portions of the cable jacket 216 of the cable 104, as depicted in FIG. 2A.

In one or more embodiments, the seating structure 404 may be recessed relative to the outer surface 408 of the outer shell 402. For instance, the outer shell 402 may define a recess 410 on at least one lateral side of the outer shell 402 (e.g., a top lateral side in the view depicted in FIG. 4) from which the seating structure 404 extends into the cable 104. As is discussed in the greater detail below, the recess 410 (e.g., an outer boundary and depth of the recess 410) may be sized and shaped to receive the cap member 208 to cover the seating structure 404 and a circuit board 202 seated within the seating structure 404.

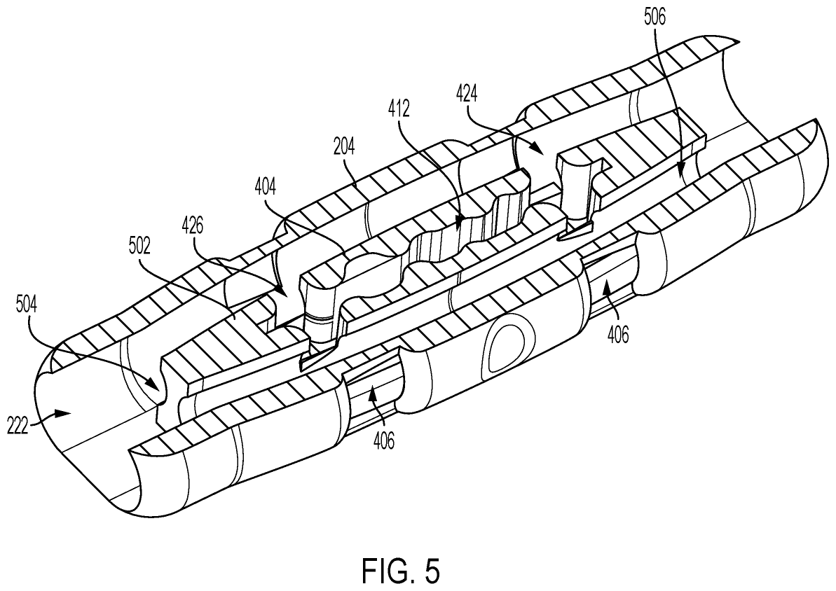

In some embodiments, the seating structure 404 may include a receiving structure 502 extending through the interior cavity 224 and from one lateral side of the outer shell 402 to an opposite lateral side of the outer shell 402. In some embodiments, the receiving structure 502 may have a general truncated-marquise shape within the XY plane, as depicted within FIG. 5. The receiving structure 502 may define a receiving channel 412 for receiving at least a portion of the circuit board 202. In some embodiments, the receiving channel 412 may extend longitudinally in a direction parallel to a center longitudinal axis of the seating structure 404. Furthermore, a depth of the receiving channel 412 may extend in a direction normal to a plane extending between center longitudinal axes of a pair of conductors 214 of a cable 104 when the housing structure 204 is formed on a cable 104 and within which the center longitudinal axes of the pair of conductors 214 lie. The receiving channel 412 may be sized and shaped to receive at least a majority of the circuit board 202 (e.g., a majority of the width of the circuit board 202) into the receiving channel 412. For example, when the circuit board 202 is seated within the receiving channel 412 of the seating structure 404, a top edge (e.g., exposed edge) of the circuit board 202 may be at least substantially flush with a bottom surface of the recess 410 formed in the outer shell 402 of the seating structure 404.

In one or more embodiments, the receiving channel 412 may be generally wider at a longitudinal center of the receiving channel 412 relative to longitudinal ends of the receiving channel 412. The wider, center portion of the receiving channel 412 may accommodate portions of the circuit board 202 having protruding profiles (e.g., semiconductor chips, resistors, diodes, capacitors, etc.) relative to lateral side surfaces of the circuit board 202. For example, the wider, center portion of the receiving channel 412 may be sized and shaped to allow insertion of the circuit board 202 into and removal of the circuit board 202 from the receiving channel 412 without substantial contact between larger profile portions of the circuit board 202 and the seating structure 404. For instance, the wider, center portion of the receiving channel 412 enables the circuit board 202 to be removed or inserted without subjecting the larger profile portions of the circuit board 202 to excessive shear stresses or force. In particular, during insertion and/or removal, there may be at least substantially persistent contact between the circuit board 202 and interior walls of longitudinal ends of the receiving channel 412, but in regions of the receiving channel 412 intersecting with the wider, center portion of the receiving channel 412, the contact between the larger profile portions of the circuit board 202 and the seating structure 404 may not include any significant forces being applied to the larger profile portions of the circuit board 202. Additionally, proximate the longitudinal ends of the receiving channel 412, the contact between the circuit board 202 and the seating structure 404 may provide for a friction fit. The friction fit may provide a relatively secure seating of the circuit board 202 within the receiving channel 412 of the seating structure 404.

Additionally, surfaces of sidewalls 414, 416 of the receiving channel 412 may have irregular topographies. For instance, the surfaces of sidewalls 414, 416 of the receiving channel 412 may have waved (e.g., wavy) topographies. As a result, the surfaces of sidewalls 414, 416 of the receiving channel 412 may define generally irregular crest portions 418 and trough portions 420. As is discussed in greater detail below, the irregular topographies of the surfaces of sidewalls 414, 416 of the receiving channel 412 assist in the formation of the housing structure 204. For instance, the crest portions 418 of the sidewalls 414 of the receiving channel 412 provide pathways during an injection molding process for material to travel through, flow through, and fill in center portions (e.g., the receiving structure 502) of the housing structure 204. In other words, the crest portions 418 of the sidewalls 414 of the receiving channel 412 may increase a cross-sectional area through which material may flow through during a injection molding process of forming the housing structure 204 relative to planar sidewalls accommodating the circuit board 202.

In some embodiments, locations of the crest portions 418 and the trough portions 420 of the sidewalls 414, 416 may be selected based on the topographies of the first lateral side 302 and the second lateral side 304 of the circuit board 202. In other words, crest portions 418 of the sidewalls 414, 416 may correlate to portions of the circuit board 202 not having raised profiles or having relatively lower profiles, and trough portions 420 of the sidewalls 414, 416 may correlate to portions of the circuit board 202 having raised profiles.

In one or more embodiments, the housing structure 204 may define an inclined recess 422 extending from a top surface of the receiving structure 502 (e.g., a bottom surface of recess 410) to the outer surface 408 of the outer shell 402 of the housing structure 204. Furthermore, the inclined recess 422 may interface with and extend from a longitudinal end of the recess 410 formed within the housing structure 204 and sized and shaped to receive the cap member 208. The inclined recess 422 may enable easy removal of the cap member 208 during operation. For instance, a tool may be inserted into the inclined recess 422 and utilized to lift the cap member 208 relative to the housing structure 204. This may enable easy access to the circuit board 202 and other portions of the sensor node 108.

In some embodiments, slots 424, 426 may be defined proximate longitudinal ends of the receiving channel 412 formed in the receiving structure 502 of the seating structure 404. Depths of the slots 424, 426 may extend into the receiving structure 502 in the same direction as the depth of the receiving channel 412 (e.g., the Z-direction, as depicted in FIG. 5). Furthermore, the slots 424, 426 may extend across an entire width of the receiving structure 502 in the Y-direction, as depicted in FIG. 5. For example, the slots 424, 426 may extend across an entire width of the receiving structure 502 in a direction orthogonal to a center longitudinal axis of the housing structure 204. The slots 424, 426 may permit the spring contacts 220 of the circuit board 202 to extend out of seating structure 404 and to contact the conductors 214 of the cable 104. For instance, the slots 424, 426 may be formed and oriented to align with the spring contacts 220 of the circuit board 202. The slots 424, 426 enable at least substantially unobstructed extension of the spring contacts 220 from the circuit board 202 and through the seating structure 404 to contact the conductors 214 of the cable 104. Furthermore, while two slots 424, 426 are depicted within the figures, the disclosure is not so limited, rather, the receiving structure 502 of the housing structure 204 may include any number of slots to accommodate any number of spring contacts.

Additionally, in some embodiments, as depicted in FIG. 5 through FIG. 7, the seating structure 404 may include two hemicylindrical recesses 504, 506 extending into the receiving structure 502 from opposing lateral side surfaces of the receiving structure 502. For example, the two hemicylindrical recesses 504, 506 may extend into the receiving structure 502 from sides of the receiving structure 502 configured to face the conductors 214 of the cable 104 when the housing structure 204 is molded on the cable 104. Each of the two hemicylindrical recesses 504, 506 may be sized and shaped to seat (e.g., at least partially receive) a conductor 214 of the cable 104. One of ordinary skill in the art will recognize that the recesses 504, 506 could have any shape in order to seat a respective conductor of a cable.

In some embodiments, the housing structure 204 may include a non-metallic material, such as, for example, a polymeric material or an elastomeric material. For example, the housing structure 204 may include one or more of polyethylene (e.g., HDPE, LDPE, PET, PET-G), thermoplastic, polylactic acid plastic, acrylonitrile butadiene styrene, polyvinyl alcohol plastic, polycarbonate, natural rubber (isoprene), elastomeric foam, styrene-butadiene rubber, butyl, nitrile, neoprene, ethylene propylene diene monomer (EPDM), silicone, Viton®, polyurethane, or hydrogenated nitrile.

In some embodiments, the housing structure 204 may be formed via one or more injection molding techniques. Furthermore, the housing structure 204 may be formed directly onto the cable 104 via one or more injection molding techniques. As a non-limiting example, the slot or opening 218 may be formed in the cable 104, and then the housing structure 204 may be formed over that cable 104 at the location of the slot or opening 218 and through the slot or opening 218, as mentioned briefly above. For example, a material of the housing structure 204 may be heated (e.g., at least substantially liquefied) and injected into a mold over the cable 104 and the slot or opening 218 formed in the cable 104 under a relatively high pressure and at a selected injection rate via a feeding system (e.g., a hydraulic feeding system). In other words, the housing structure 204 may be formed over the cable 104 and the slot or opening 218 formed in the cable 104 via an injection overmolding process. The feeding system may include one or more of a hot runner injection system or a cold runner injection system. The mold may include a two or three plate mold forming one of a single cavity mold, a multicavity mold, or a family mold. The material may be left to cool to form the housing structure 204. As additional non-limiting examples, the housing structure 204 may be formed via one or more of thin-wall injection molding, reaction injection molding, micro injection molding, gas-assisted injection molding, and/or cube mold technology.

Referring to FIG. 2A through FIG. 7 together, the seal member 206 may be positioned between the cap member 208 and the housing structure 204 and may be configured to provide seals between the conductors 214 exposed within the slot or opening 218 (and the circuit board 202) and external environments (e.g., liquids or other materials). In some embodiments, a boundary of the seal member 206 within the XY plane, as depicted within FIG. 2A, may be at least substantially the same a boundary of the cap member 208. Furthermore, the boundary of the seal member 206 within the XY plane, as depicted within FIG. 2A, may be at least substantially the same as a boundary of the recess 410 of the housing structure 204. For example, the seal member 206 may be sized and shaped to be seated within the recess 410 of the housing structure 204. Furthermore, a longitudinal length of the seal member may exceed longitudinal lengths of the receiving channel 412 and the circuit board 202.

In one or more embodiments, the seal member 206 may include an opening 226 extending through the seal member 206 and located to at least substantially align with the filter and/or membrane 210 of the sensor node 108 and the recessed aperture 222 of the cap member 208 when the sensor node 108 is assembled. The opening 226 of the seal member 206 may enable air and/or vapor (e.g., water vapor) to reach the circuit board 202 and the sensors of the circuit board 202 through the filter and/or membrane 208. In some embodiments, the opening 226 of the seal member 206 may have a smaller cross-section (e.g., diameter) than a cross-section (e.g., diameter) of the filter and/or membrane 210, such that the seal member 206 maintain seals against and proximate peripheral boundaries of the filter and/or membrane 210. In some embodiments, the seal member 206 may not include the opening and the sensor node 108 may not include a respective filter and/or membrane 210, e.g., in temperature sensing only applications. The filter and/or membrane 210 is described in greater detail below.

The seal member 206 may further include one or more key apertures 228 for receiving key structures of the cap member 208 in order to hold the seal member 206 in a fixed position relative to the cap member 208, as is described in further detail below. Furthermore, as discussed in greater detail below, the one or more key apertures 228 may be sized, shaped, and oriented to align with the one or more key apertures 228 of the seal member 206. As a result, the one or more key structures of the cap member 208 may assist in holding the seal member 206 in place and orienting the seal member 206 relative to the cap member 208 when the sensor node 108 is assembled. In some embodiments, the seal member 206 may include one or more of an elastomeric material or a polymeric material. For example, the seal member 206 may include one or more of natural rubber (isoprene), styrene-butadiene rubber, butyl, nitrile, neoprene, ethylene propylene diene monomer (EPDM), silicone, Viton®, polyurethane, or hydrogenated nitrile.

In some embodiments, the seal member 206 may be bonded to the housing structure 204 within the recess 410 of the housing structure 204. For example, the seal member 206 may be bonded to the cable 104 via an adhesive (e.g., glue, epoxy, etc.). In additional embodiments, the seal member 206 may be ultrasonically welded into the recess 410 of the housing structure 204. In yet further embodiments, the seal member 206 may be secured to the cable 104 via one or more over molding techniques. In yet further embodiments, the seal member 206 may be secured between the cap member 208 and the housing structure 204 via the one or more fasteners 212 as is described in further detail below.

As mentioned above, the cap member 208 may be sized and shaped to fit within the recess 410 formed in the outer shell 402 of the housing structure 204 and over the seal member 206. In some embodiments, the cap member 208 may have a general elongated-pill shape within the XY plane depicted in FIG. 2C. Furthermore, the cap member 208 may have a thickness in the Z-direction such that, when the cap member 208 is placed over the seal member 206 within the recess 410 and secured to the housing structure 204, an exposed surface of the cap member 208 extends beyond the surrounding outer surfaces 408 of the outer shell 402. In other words, a combined thickness of the seal member 206 and the cap member 208 may be larger than a depth of the recess 410. Furthermore, in some embodiments, the cap member 208 may have a general oval domed exterior surface.

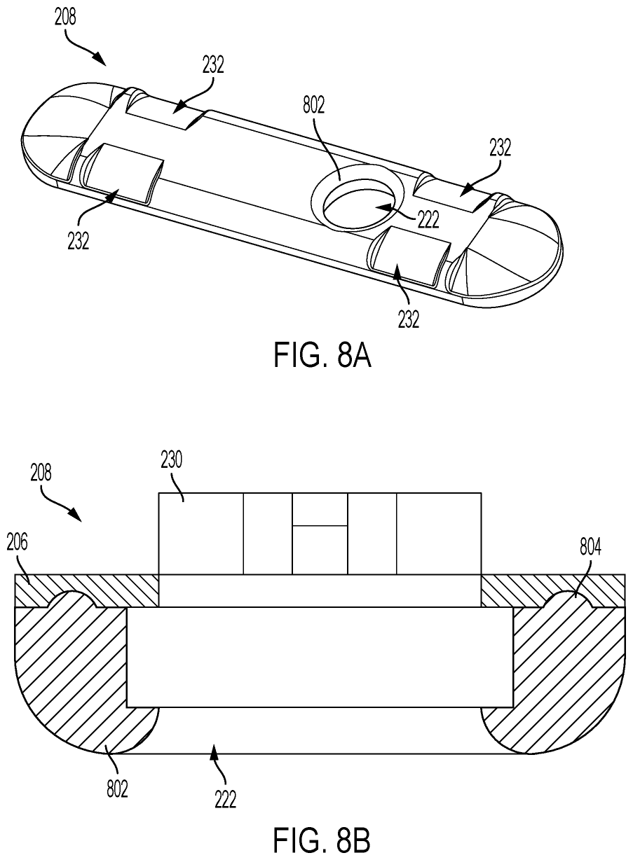

As mentioned briefly above, the cap member 208 may include a recessed aperture 222 extending through the cap member 208 from one major surface of the cap member 208 to an opposite major surface of the cap member 208 (e.g., in the Z-direction). FIG. 8A shows a perspective view of the cap member 208 according to one or more embodiments. FIG. 8B shows a cross-sectional side view of the cap member 208 of FIG. 8A within the XZ plane. Referring to FIG. 2A through FIG. 8B together, the recessed aperture 222 may be sized and shaped to receive a filter and/or membrane 210. As shown, the recessed aperture 222 may be recessed relative to the external surface of the cap member 208. Furthermore, the cap member 208 may include an annular ridge 802 extending radially inward from a cylindrical surface defining the recessed aperture 222. The annular ridge 802 may be sized and shaped to prevent the filter and/or membrane 210 from falling out of the recessed aperture 222. For instance, the filter and/or membrane 210 may be inserted into the recessed aperture 222 from a back side (e.g., a side of the cap member 208 configured to face the circuit board 202 when the sensor node 108 is assembled), and the annular ridge 802 may prevent the filter and/or membrane 210 from falling out of the recessed aperture 222 at a front side of the cap member 208 via mechanical interference. Furthermore, when the cap member 208 is installed on a sensor node 108, the filter and/or membrane 210 may be held in place between the cap member 208 and the housing structure 204.

As mentioned briefly above, the cap member 208 may include one or more key structures 230, and the key structures 230 may extend from a back side of the cap member 208 (e.g., a side of the cap member 208 configured to face the housing structure 204). Cross-sectional shapes of the one or more key structures 230 of the cap member 208 within the XY plane may at least substantially match cross-sectional shapes of the one or more key apertures 228 of the seal member 206 within the XY plane such that, when the cap member 208 and the seal member 206 are assembled together, the one or more key structures 230 of the cap member 208 may align with and extend through the one or more key apertures 228 of the seal member 206. As a result, the one or more key structures 230 of the cap member 208 may hold the seal member 206 in place relative to the cap member 208 within the XY plane via mechanical interference with the portions of the seal member 206 defining the one or more key apertures 228. Additionally, in some embodiments, the cross-sectional shapes of the one or more key structures 230 of the cap member 208 within the XY plane may at least generally correlate to cross-sectional shapes of portions of the receiving channel 412 and slots 424, 426 within the XY plane such that, when the cap member 208, the seal member 206, and the housing structure 204 are assembled together, the one or more key structures 230 of the cap member 208 may align with and at least partially extend into the portions of the receiving channel 412 and slots 424, 426. Having the one or more key structures 230 of the cap member 208 may align with and at least partially extend into the portions of the receiving channel 412 and slots 424, 426 may prevent the cap member 208 from significantly moving relative to the housing structure 204 when the sensor node 108 is assembled.

In one or more embodiments, the cap member 208 may include one or more fastener receiving structures 232 formed in portions of an outer side (e.g., external side) of the cap member 208. The fastener receiving structures 232 may be sized and shaped to receive portions the fasteners 212 extending over the cap member 208 when the sensor node 108 is assembled (FIG. 2A). As a result, the fastener receiving structures 232 may prevent the cap member 208 from significantly moving relative to the fastener 212 via mechanical interference with each other and vice-versa when the sensor node 108 is assembled.

In some embodiments, the fasteners 212 may include clamps (e.g., circle clamps), and the clamps may partially fit into the fastener receiving structures 232 of the cap member 208. In additional embodiments, the fasteners 212 may include ties or other types of fasteners. The fasteners 212 may be fastened (e.g., tightened) to press and secure the cap member 208 onto the seal member 206 within recess 410 of the housing structure 204. In one or more embodiments, when the fasteners 212 are installed on the sensor node, the fasteners 212 may align axially with windows 406 formed in the housing structure 204 along a longitudinal axis of the sensor node 108. As a result, the fasteners 212 may be received into recessed portions of the housing structure 204 formed by the windows 406. In view of the foregoing, the fastener receiving structures 232 of the cap member 208 may also align axially with windows of the housing structure 204 along the longitudinal axis of the sensor node 108. In some embodiments, the fasteners 212 may extend completely around the sensor node 108 within a ZY plane.

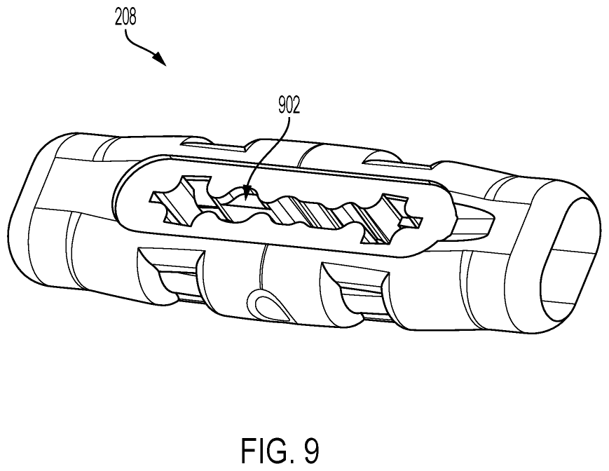

FIG. 9 shows another perspective view of the housing structure 204 according to one or more embodiments. In some embodiments, the housing structure 204 may include a filter pathway 902. In one or more embodiments, the filter pathway 902 may include a recess interfacing with the receiving channel 412 and being recessed relative to the recess 410 for receiving the cap member 208. Furthermore, the filter pathway 902 may be located to at least substantially align with the filter and/or membrane 210 along a longitudinal length of the sensor node 108 when the sensor node 108 is assembled. The filter pathway 902 may provide an air pathway between sensors of the circuit board 202 and the filter and/or membrane 210. Furthermore, the filter pathway 902 may provide a pathway for air external to the sensor node 108 to reach the sensors of the circuit board 202 through the filter and/or membrane 210. As a result, the filter pathway 902 may improve performance of and the accuracy of measurements captured by the sensors of the circuit board 202 during use relative to sensor nodes not including the filter pathway 902. Accordingly, filter pathway 902 may improve performance of and the accuracy of measurements captured by the sensor node 108.

The filter and/or membrane 210 may include a hydrophobic filter and/or membrane. The hydrophobic filter and/or membrane may enable air and/or vapor (e.g., water vapor) to reach the circuit board 202 and the sensors of the circuit board 202 while preventing liquid water (or other liquids and fluids) from passing through the hydrophobic filter and/or membrane. As noted above, in some embodiments, the circuit board 202 may include one or more of humidity sensors, relative humidity sensors, temperature sensors, moisture sensors, and/or carbon dioxide (CO2) sensors. As a non-limiting example, the filter and/or membrane 210 may include a fluoropolymer tetrafluoroethylene (PTFE) material or any other hydrophobic material. The filter and/or membrane 210 may include filters and/or membranes of various sizes and/or geometries selected based at least partially on a region (e.g., anticipated climate) of the container and/or the stored commodity. In some embodiments, the cap member 208 may not include apertures and may not include a respective filter and/or membrane 210, e.g., in temperature sensing only applications.

Additionally, the circuit board 202 may include a relative humidity sensor. In such embodiments, the circuit board 202 may include one or more air passageways extending through the circuit board 202 and from the first lateral side 302 to the second lateral side 304 of the circuit board 202. The air passageways may permit air, and as a result, vapor to reach the humidity sensor from both sides of the circuit board 202. For instance, the humidity sensor may be at least substantially aligned with the air passageway.

In some embodiments, the cap member 208 may be secured to the housing structure 204 via the one or more fasteners. The cap member 208 may be positioned over the seal member 206, the circuit board 202, and slot or opening 218 formed in the cable 104 and may be configured, in combination with the seal member 206, to provide a seal between the circuit board 202 and external environments (e.g., liquids or other materials). Longitudinal lengths of the cap member 208 may exceed longitudinal lengths of the circuit board 202. In some embodiments, the cap member 208 may include one or more of a thermoplastic material or an elastomeric material. For example, the cap member 208 may include one or more of acrylonitrile butadiene styrene (ABS), nylon, polylactide, Polybenzimidazole, Polycarbonate, Polyether sulfone, Polyoxymethylene, Polyether ether ketone, Polyetherimide, Polyethylene, Polyphenylene oxide, Polyphenylene sulfide, Polypropylene, Polystyrene, Polyvinyl chloride, Polyvinylidene fluoride, Polytetrafluoroethylene, natural rubber (isoprene), styrene-butadiene rubber, butyl, nitrile, neoprene, ethylene propylene diene monomer (EPDM), silicone, Viton®, polyurethane, or hydrogenated nitrile.

In some embodiments, the cap member 208 may be formed via one or more additive manufacturing processes (e.g., 3D printing processes). In other words, the cap member 208 may be additive manufactured. For example, the cap member 208 may be formed via one or more of fused deposition modeling, direct metal deposition, micro-plasma powder deposition, direct laser sintering, selective laser sintering, electron beam melting, electron beam freeform fabrication, stereolithography (SLA), inkjet 3D printing, and other additive manufacturing process. In yet further embodiments, the cap member 208 may be formed via injection molding.

When the sensor node 108 is assembled, the housing structure 204 may be formed over a cable 104 and a slot or opening 218 formed in the cable 104, and the circuit board 202 may be inserted (e.g., seated) into the seating structure 404 of the housing structure 204 (e.g., within the receiving channel 412 of the seating structure 404). As stated above, when the housing structure 204 is formed over the cable 104, the seating structure 404 may be formed in between (i.e., interposed between) the pair of conductors 214 of the cable 104 and through the slot or opening 218 in the cable jacket 216. Furthermore, as noted above, when the circuit board 202 may be inserted (e.g., seated) into the seating structure 404 of the housing structure 204 (e.g., within the receiving channel 412 of the seating structure 404), a top edge of the circuit board 202 may be at least substantially flush with an upper surface of the seating structure 404.

When inserted into a seating structure 404 of a housing structure 204 formed on a cable 104, a longitudinal axis of the circuit board 202 may be oriented at least substantially parallel to a longitudinal axis of the cable 104. For instance, in some embodiments, a center longitudinal axis of the circuit board 202 may be at least substantially collinear with a center longitudinal axis of the cable 104. Furthermore, the first lateral side 302 of the circuit board 202 may face a first conductor 214 of the pair of conductors 214, and the second, opposite lateral side 304 of the circuit board 202 may face a second conductor 214 of the pair of conductors 214. Additionally, as described above, when circuit board 202 is inserted in between the pair of conductors 214 of the cable 104, the spring contacts 220 of the circuit board 202 may press against the pair of conductors 214 of the cable 104. Contact between the spring contacts 220 and the conductor 214 on each lateral side of the circuit board 202 assists in securing the circuit board 202 within the cable 104 and provides electrical connections between the circuit board 202 and the conductors 214 of the cable 104 for power and/or data transfer.

Referring to FIG. 1 through FIG. 3B together, in some embodiments, sensor nodes 108 of a given cable 104 may be spaced apart from one another along a length of the cable 104 by a distance within a range of about 0.3 meter and 4.8 meters. For instance, the sensor nodes 108 of a given cable 104 may be spaced apart from one another along a length of the cable 104 by a distance 0.3 meter, 0.6 meter, 1.2 meters, 2.4 meters, or 4.8 meters.

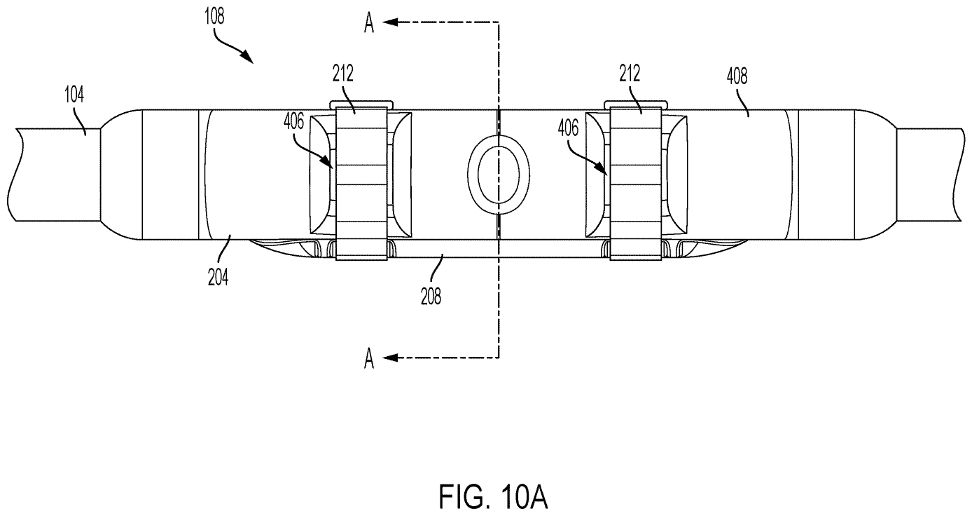

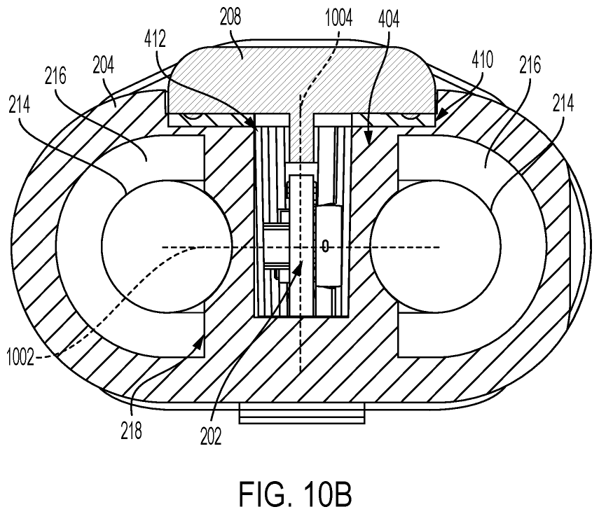

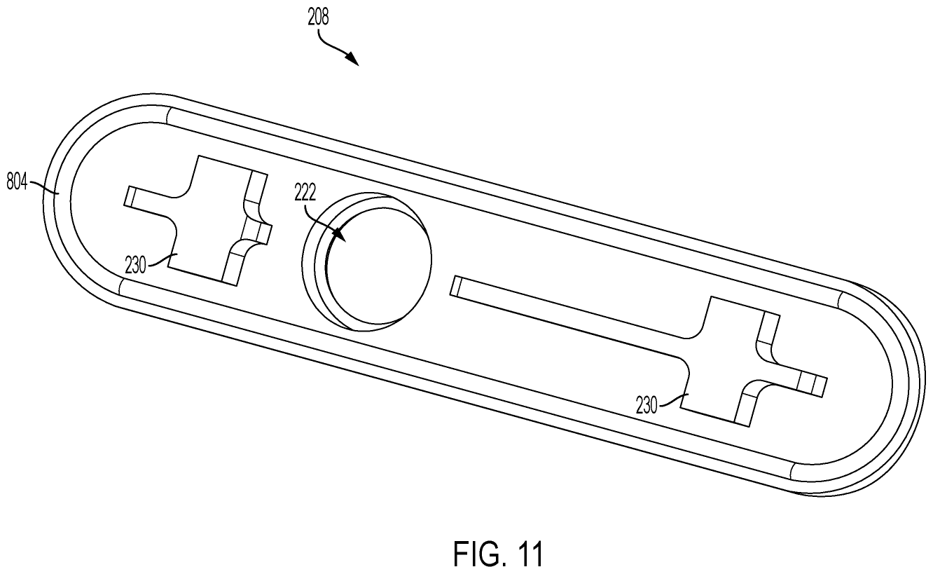

FIG. 10A is a side view of a sensor node 108 in an assembled configuration. FIG. 10B is a cross-sectional view of the sensor node 108 of FIG. 10A along line A-A. Referring to FIG. 10A and FIG. 10B together, the sensor node 108 may include any of the elements of the sensor nodes 108 described above in regard to FIGS. 1-9. As shown in the view depicted in FIG. 10A, the sensor node 108 may have an at least substantially a symmetrical outer profile about a ZX plane.

During a process of making and assembling the sensor node 108, as discussed above, the housing structure 204 of the sensor node 108 may be formed via one or more injection molding techniques. Additionally, the housing structure 204 may be formed directly onto the cable 104 via one or more injection molding techniques. For example, the slot or opening 218 may be formed in the cable 104, and then the housing structure 204 may be formed over that cable 104 at the location of the slot or opening 218 and through the slot or opening 218. As a non-limiting example, a material of the housing structure 204 may be heated (e.g., at least substantially liquefied) and injected into a mold over the cable 104 and the slot or opening 218 formed in the cable 104 under a relatively high pressure. The material may be left to cool to form the housing structure 204.

Subsequent to forming the housing structure 204, the circuit board 202 may be disposed within the receiving channel 412 of the seating structure 404. Additionally, the receiving channel 412 of the seating structure 404 may be sized and shaped to receive a lateral edge of the circuit board 202 and to secure the circuit board 202 (e.g., via friction fit or over molding fit) relative to the housing structure 204 and the conductors 214.

In the view depicted in FIG. 10B, a plane 1002 may extend between center longitudinal axes of the conductors 214 and the center longitudinal axes of the conductors 214 may lie within the plane 1002. It should be noted that the cable jacket 216 includes outer, substantially-planar surfaces that are at least substantially parallel to the plane 1002.

When the circuit board 202 is held within the receiving channel 412 of the seating structure 404 of the housing structure 204, lateral surfaces (i.e., major surfaces) of the circuit board 202 defining the first lateral side 302 and the second lateral side 304 of the circuit board 202 may be at least substantially perpendicular to the plane 1002 extending between center longitudinal axes of the conductors 214. Moreover, the lateral surfaces (i.e., major surfaces) of the circuit board 202 defining the first lateral side 302 and the second lateral side 304 may be perpendicular to the planar surfaces of the cable jacket 216. Furthermore, the lateral surfaces (i.e., major surfaces) of the circuit board 202 defining the first lateral side 302 and the second lateral side 304 may face opposing conductors 214 of the cable 104. In view of the foregoing, a center plane 1004 of the circuit board 202 falling within the Z-Y plane, in the view depicted in FIG. 10B, may be perpendicular to the plane 1002 extending between center longitudinal axes of the conductors 214 and the planar surfaces of the cable jacket 216.

However, in some additional embodiments, the circuit board 202 may be skewed relative to the Z-axis, and the lateral surfaces (i.e., major surfaces) of the circuit board 202 defining the first lateral side 302 and the second lateral side 304 may not be perpendicular to the plane 1002 extending between center longitudinal axes of the conductors 214.

Regardless, the circuit board 202 may be disposed into the receiving channel 412 of the seating structure 404 with the spring contacts 220 of the circuit board 202 extending through slots (e.g., slots 424, 426) of the seating structure 404 and pressing against the conductors 214 of the cable 104. Having the spring contacts 220 of the circuit board 202 press against the conductors 214 of the cable 104 may at least partially secure the circuit board 202 in place and create electrical connections (e.g., data, power, and/or ground connections) between the conductors 214 and the circuit board 202.

Additionally, the filter and/or membrane 210 may be disposed within the recessed aperture 222 of the cap member 208. In some embodiments, the filter and/or membrane 210 may be press fit into the recessed aperture 222 of the cap member 208. In additional embodiments, the filter and/or membrane 210 mold fit into the recessed aperture 222 of the cap member 208. As noted above, the filter and/or membrane 210 may permit air and vapors to pass through the housing structure 204 and reach the circuit board 202. In some embodiments, the one or more filters and/or membranes 210 may include a fluoropolymer tetrafluoroethylene (PTFE) material or any other hydrophobic material.

Subsequent to disposing the circuit board 202 within the receiving channel 412 of the seating structure 404, the seal member 206 and the cap member 208 may be secured within the recess 410 and over the circuit board 202. As mentioned above, in some embodiments, the seal member 206 and the cap member 208 may be secured to the housing structure 204 and within the recess 410 via one or more fasteners 212. In some embodiments, one or more of the seal member 206 and the cap member 208 may be secured to the housing structure 204, the cable 104, and/or each other via one or more ultrasonic welding processes. For instance, one or more of the cap member 208 and/or the housing structure 204 may include one or more energy director structures utilized in ultrasonic welding processes for bonding the cap member 208 to the housing structure 204.

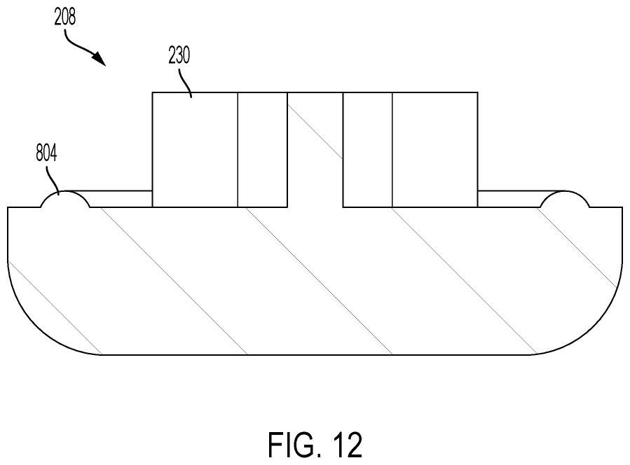

FIG. 11 shows a perspective view of an underside (e.g., back side) of a cap member 208 according to one or more embodiments of the disclosure. FIG. 12 shows a simplified, side view of the cap member 208 of FIG. 11. As shown, the cap member 208 may include a sealing ridge 804 extending from the backside of the cap member 208. The sealing ridge 804 may include a single structure that extends around and proximate an outer perimeter of the cap member 208. The sealing ridge 804 may be at least substantially continuous and may be at least substantially concentric to the outer perimeter of the cap member 208. In some embodiments, the sealing ridge 804 may include a hemicylindrical protrusion. In operation, the sealing ridge 804 may press against and into the seal member 206 and may increase pressure applied by the seal member 206 to the housing structure 204 along the sealing ridge 804. As a result, the sealing ridge 804 may improve a seal formed between the seal member 206 and the housing structure 204 when the sensor node 108 is assembled.

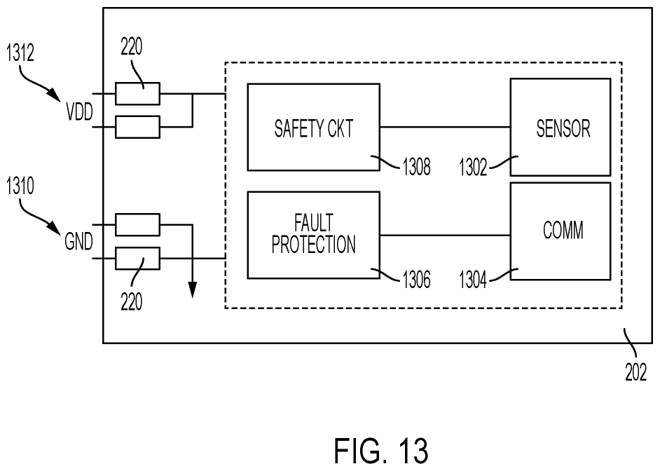

FIG. 13 shows a block diagram of the circuit board 202 according to one or more embodiments of the disclosure. In some embodiments, the circuit board 202 may include sensors 1302, a communication interface 1304, fault protection circuitry 1306, and safety circuitry 1308.

The sensors 1302 may include any of the sensors described herein. For example, the sensors 1302 may include one or more of temperature sensors, humidity sensors, relative humidity sensors, or carbon-dioxide sensors. In some embodiments, the sensors 1302 may include low voltage, low power sensors.

The communication interface 1304 may include hardware, software, or both. The communication interface 1304 may provide one or more interfaces for communication (such as, for example, packet-based communication) between a computer device (e. g, cable hub 118, at least one client device 110, or gateway 120) and one or more other computing devices or networks (e.g., at least one server 112). As an example, and not by way of limitation, the communication interface 1304 may include a network interface controller (NIC) or network adapter for communicating with an Ethernet or other wire-based network or a wireless NIC (WNIC) or wireless adapter for communicating with a wireless network, such as a WI-FI.

The fault protection circuitry 1306 may include any conventional fault protection circuitry and may be configured to guard against faults. The safety circuitry 1308 may include any conventional safety circuitry and may be configured to provide intrinsic safety for use in hazardous environments. In some embodiments, the circuit board 202 may further include any conventional microcontroller unit (MCU) that may provide for management and control of the circuit board 202. In some embodiments, the circuit board 202 may not include an MCU, but rather, each of the sensors 1302 may include integrated circuit sensors with respective logic, communication, and sensing abilities. The spring contacts 220 may establish a ground connection 1310 and a power/data connection 1312 (e.g., a positive voltage supply (VDD)) with the conductors 214 of the cable 104.

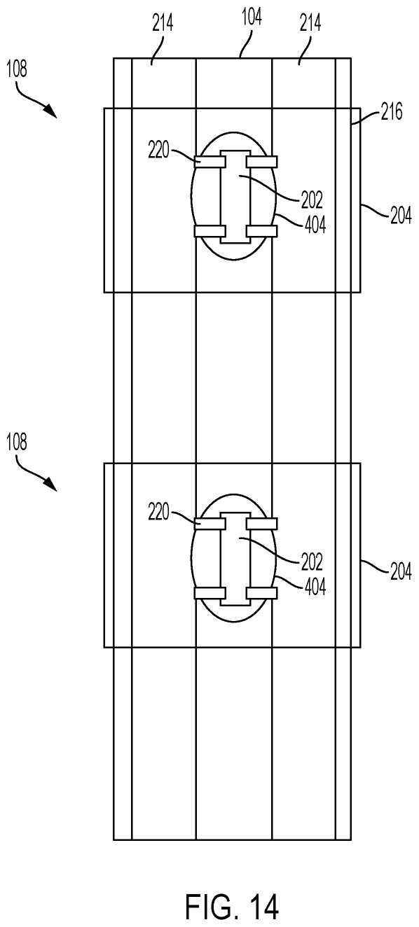

FIG. 14 shows a simplified, schematic view of a cable 104 including example sensor nodes 108 distributed along lengths of the cables 104 according to one or more embodiments of the disclosure. The example sensor nodes 108 are for illustrative, non-exhaustive purposes, and it will be understood by one having ordinary skill in the art in the context of the present disclosure that additional variations may be implemented and are within the scope of the disclosure. The seal member is removed from FIG. 14 for illustrative purposes.

The sensor nodes 108 may include any of the housing structures 204 described above. In some embodiments, the circuit board 202 of the sensor nodes 108 may include two spring contacts 220 on one lateral side of the circuit board 202 and two spring contacts 220 on an opposite lateral side of the circuit board 202. The spring contacts 220 may extend through the housing structure 204 via any of the manners described above and press against respective conductors 214 of the cable 104. Having a pair of spring contacts 220 on each side of the circuit board 202 may improve operational reliability in regard to the circuit board 202 and may provide redundancy should one of the data or ground sets of spring contacts 220 fail (e.g., corrode). Additionally, having a pair of spring contacts 220 on each side of the circuit board 202 may reduce costs by using a mix of conductive and non-conductive spring contacts 220.

While each respective cable 104 is shown as having sensor nodes 108 of a same variety (e.g., one spring contact 220 on each side, a pair of spring contacts 220 on each side, three spring contacts 220 of on each side), the disclosure is not so limited, and the sensor nodes 108 of a given cable 104 may vary in variety long a length of the cable 104.

Referring to FIG. 1 through FIG. 14 together, the cable assembly 102 and sensor nodes (referred to hereinafter collectively with the numeral “108”) may provide advantages over conventional cable assemblies and sensor nodes. For example, typical sensor nodes include a circuit board soldered to conductors of a cable, and the circuit board is conventionally soldered to one side of both conductors (e.g., above or below the conductors as depicted in FIG. 14). As a result, movement of the cable can result in movement of a circuit board of a sensor node and breaks in one or more solder contacts, which can render the sensor node non-functional. In contrast, the sensor nodes 108 of the disclosure are secured between the conductors 214 of the cable 104 and maintain contact with the conductors 214 via spring contacts 220. As a result, movement of the cable 104 does not result in break in connections between the circuit board 202 and the conductors 214. Accordingly, in comparison to conventional sensor nodes, the spring contacts 220 of the sensor nodes 108 of the disclosure provide for a more robust securement of the circuit board 202 to the conductors 214 under conditions of cable 104 movement, which improves the reliability of the sensor nodes 108.

Furthermore, conventional soldering increases costs in fabrication and/or repair and requires specific tools to create the solder contacts and perform inspections to check the integrity of the solder contacts. Alternatively, other affixing mechanisms also introduce added field or manufacturing costs. For instance, conventional crimp mechanisms utilized to affix circuit boards to conductors of the cable require tools for the crimp operation and require intensive inspections to determine the integrity of the crimp. In contrast, the spring contacts 220 of the sensor nodes 108 of the disclosure secure the circuit board 202 to the conductors 214 of the cable 104 without a need for additional tools. The foregoing facilitates relatively easy installation and field replacement of the sensor nodes 108 in comparison to conventional sensors and cables. Additionally, the spring contacts 220 of the sensor node 108 of the disclosure enable relatively easy tests and inspections of the sensor nodes 108 in regard to attachment and/or securement. The foregoing may reduce a required number or frequency of inspections and may increase a quality of the inspections when compared to the inspections required for soldered or crimped connections. Accordingly, the spring contacts 220 of the sensor node 108 of the disclosure improves reliability of the sensor nodes 108 and decreases time and costs involved with installation of the sensor nodes 108 and/or field replacement testing.

Moreover, because the circuit board 202 of the sensor nodes 108 of the disclosure is arranged in between the conductors 214 of the cable 104, as opposed to on top or below the conductors 214, the sensor nodes 108 of the disclosure may exhibit a reduced profile in comparison conventional sensor nodes. For instance, conventional sensor nodes typically exhibit a pronounced profile relative to a profile of a respective cable. The pronounced profile results relatively high shear forces being imposed on the sensor node by the commodity within the container. The reduced profile of the sensor nodes 108 of the disclosure reduces shear forces experienced by the sensor nodes 108 due to the commodity. Accordingly, the load placed on the cables 104 by the commodity is also reduced. Reducing the load on the cables 104 reduces the load on the cable assembly 102 and may provide a more durable cable assembly 102.

All references cited herein are incorporated herein in their entireties. If there is a conflict between definitions herein and in an incorporated reference, the definition herein shall control.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

1. A sensor node, comprising:
a segment of a cable comprising a pair of conductors surrounded by a cable jacket;
an injection molded housing structure formed over the cable and extending through a slot extending through the cable;
a circuit board disposed within the housing structure and between conductors of the pair of conductors;
a seal member disposed over the circuit board and in contact with the housing structure;
a cap member disposed over the seal member; and
at least one fastener securing the seal member and the cap member to the housing structure.

2. The sensor node of claim 1, wherein the circuit board comprises a plurality of spring contacts extending away from lateral sides of the circuit board and configured to contact the pair of conductors of the cable.

3. The sensor node of claim 2, wherein at least one spring contact of the plurality of spring contacts extends from a first lateral side of the circuit board, and at least one other spring contact of the plurality of spring contacts extends from a second, opposite lateral side of the circuit board.

4. The sensor node of claim 2, wherein a center longitudinal axis of the circuit board is at least substantially collinear with a center longitudinal axis of the cable.

5. The sensor node of claim 1, wherein the at least one fastener comprises a circle clamp extending around the cap member and the housing structure within a plane to which a longitudinal axis of the cable is orthogonal.

6. The sensor node of claim 1, wherein the seal member comprises at least one key aperture for aligning the seal member relative to the cap member.

7. The sensor node of claim 6, wherein the cap member comprises at least key structure configured to extend through the at least one key aperture of the seal member.

8. The sensor node of claim 5, wherein the housing structure comprises a recess within which the seal member and the cap member are received.

9. The sensor node of claim 8, wherein the housing structure further comprises an inclined recess extending between the recess and an outer surface of the housing structure.

10. The sensor node of claim 5, wherein the cap member comprises a recessed aperture extending through the cap member.

11. The sensor node of claim 10, further comprising at least one filter or membrane disposed within the recessed aperture of the cap member and providing a hydrophobic vent.

12. The sensor node of claim 1, wherein the housing structure comprises a seating structure extending through the cable and between the pair of conductors.

13. The sensor node of claim 12, wherein receiving channel extends through the seating structure.

14. The sensor node of claim 1, wherein each lateral side surface of the circuit board faces a respective conductor of the pair of conductors, and wherein each lateral side surface of the circuit board is oriented at least substantially perpendicular to a plane extending between center longitudinal axes of the pair of conductors of the cable and within which the center longitudinal axes of the pair of conductors lie.

15. The sensor node of claim 1, wherein the circuit board comprises one or more sensors.

16. The sensor node of claim 15, wherein the one or more sensors comprise at least one of a temperature sensor, a moisture sensor, a humidity sensor, a relative humidity sensor, or a carbon dioxide sensor.

17. A method of forming a sensor node on a cable, comprising:
forming an opening in a cable jacket of the cable;
injection molding a housing structure over the opening in the cable jacket of the cable and at least partially through the cable such that at least a portion of the housing structure is formed between two conductors of the cable,
disposing a circuit board within the housing structure such that a first lateral side of the circuit board faces a first conductor of the two conductors and a second lateral side of the circuit board faces a second conductor of the two conductors;
disposing a seal member over the circuit board and onto the housing structure;
aligning a cap member over the seal member; and
securing the cap member to the housing structure via at least one fastener.

18. The method of claim 17, wherein aligning the cap member over the seal member comprises aligning at least one key structure of the cap member within at least one key aperture of the seal member.

19. The method of claim 17, wherein securing the cap member to the housing structure via the at least one fastener comprises securing the cap member to the housing structure via at least one circle clamp.

20. A commodity monitoring system, comprising:
at least one computing device;
a container for storing a commodity; and
a cable assembly installed within the container and in communication with the at least one computing device, the cable assembly comprising:
a plurality of cables, each cable comprising a pair of conductors surrounded by a cable jacket; and
a plurality of sensor nodes secured to the plurality of cables, each cable of the plurality of cables having at least one sensor node of the plurality of sensor nodes secured thereto, each sensor node of the plurality of sensor nodes comprising:
a segment of a cable of the plurality of cables;
an injection molded housing structure formed over the cable and extending through a slot extending through the cable;
a circuit board disposed within the housing structure and between conductors of the pair of conductors;
a seal member disposed over the circuit board and in contact with the housing structure;
a cap member disposed over the seal member; and
at least one fastener securing the seal member and the cap member to the housing structure.
